(19) United States
(12) Patent Application Publication
(10) Pub. No.: US 2001/0028239 A1
(43) Pub. Date: Oct. 11, 2001

(54) Triac controller having soft start speed regulation

(76) Inventor: Henri Vanderhenst, Hamont-Achel (BE)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/801,567

(22) Filed: Mar. 7, 2001

Related U.S. Application Data
(60) Provisional application No. 60/188,308, filed on Mar. 10, 2000.

(51) Int. Cl. G05F 1/10

(52) U.S. Cl. 323/235

(57) ABSTRACT

A triac controller includes a triac driver that provides a triac control signal suitable for connection to a gate terminal of a triac, such that, when in a power-on condition, the control signal carries at least a first firing pulse during each half period of the alternating current power supply. A soft start subcircuit and a zero crossing detector directs the triac driver to produce the first firing pulse at a first firing pulse delay time after the zero crossing time. During a soft start operation the first firing pulse delay time varies monotonically with each successive half period from an initial delay time to a final delay time. An auto-retriggering subcircuit causes the triac driver to produce a second firing pulse at a predetermined retriggering delay time from an end of the first firing pulse if the triac is not in an on conduction state after the end of the first firing pulse during a same half period. The auto-retriggering subcircuit causes the triac driver to produce retriggering firing pulses periodically for so long as the triac is not in the on conduction state during the same half period; however, it is inhibited from causing the triac driver to produce retriggering firing pulses during a predetermined retriggering mask period at an end of the same half period. The soft start subcircuit includes a table specifying a plurality of predetermined first firing pulse delay values. A set signal is used to determine an index into the table. The plurality of predetermined first firing delay values is monotonically organized with respect to the index into the table, and a programmable rate variable determines a rate of change of the first firing delay values during a soft start operation.

### CROSS-REFERENCES TO RELATED APPLICATION

This Non-Provisional Utility Patent Application claims priority on Provisional Application No. 60/188,308, filed on Mar. 10, 2000, entitled “Low Cost Motor With Speed Controller.”

### BACKGROUND OF THE INVENTION

1. Field of the Invention

The present invention pertains to the field of supplying power to alternating current (AC) devices. Specifically, the present invention pertains to controlling variable speed AC devices, such as AC motors, or variable power AC devices, such as incandescent AC light bulbs, which may be dimmed through the use of a dimmer control.

2. Discussion of the Related Art

In a circuit configuration in which a motor is directly connected to an alternating current power supply, such as through an ON/OFF switch, there is a current surge through the motor as the motor accelerates from an angular velocity of zero to its final steady-state angular velocity.

For example, FIG. 1 plots rotational speed 101 in the Y-dimension versus time in the t-dimension and current consumption 102 in the Y-dimension versus time in the t-dimension for a motor during a conventional power on operation in which a conventional alternating current power supply is directly connected to a motor at a power on time 103. The current consumption at power on is very high, and it approaches the final steady state current consumption asymptotically. Similarly, the rotational speed 101 of the motor begins at zero and increases to its final speed asymptotically.

Very high currents which occur during transitions of the motor speed are potentially dangerous and destructive to the circuit elements for several reasons. Therefore, it is desirable to develop a system in which the motor current is controlled to ensure that the rate of change of speed of the motor and the current drawn by the motor are controlled within predetermined limits.

### SUMMARY OF THE INVENTION

An object of the present invention is to provide a controller that supplies alternating current power to a motor or other load that ensures that the rate of change of speed of the motor and the current drawn by the motor are controlled within predetermined limits. According to an embodiment of the present invention, a power control integrated circuit is ideally suited for control of any resistive or inductive load regulated by a triac. The embodiment of the present invention is designed for starting and speed control of AC motors, but will work equally well with any inductive or resistive load such as incandescent light bulbs. According to the present invention, an integrated circuit has arranged thereon circuits for controlling the speed of a motor driven by an alternating current power supply (such as 240 Volt alternating current) via a triac (bidirectional triode thyristor) so as to ensure that the rate of change of speed of the motor and the current drawn by the motor are controlled within predetermined limits.

According to an aspect of the present invention, the integrated circuit provides a “soft start” function for a motor, thereby preventing undesirable high current inrush. In a preferred embodiment, the triac is controlled so as to supply power at levels described by a linear up-sloping “ramp” from a minimum power level to a maximum power level. The delay from a zero crossing time to a first firing pulse delay time determines the duration for each half period during which the power supply can supply current to the load.

A triac controller according to the present invention includes a zero crossing detector, a triac driver, and a soft start subcircuit. The zero crossing detector determines a zero crossing time at which an alternating current power supply having positive and negative half periods changes voltage polarity. The triac driver provides a triac control signal suitable for connection to a gate terminal of a triac, such that, when in a power-on condition, the control signal carries at least a first firing pulse during each half period of the alternating current power supply. The soft start subcircuit is coupled to the triac driver and the zero crossing detector and directs the triac driver to produce the first firing pulse at a first firing pulse delay time after the zero crossing time. During a soft start operation the first firing pulse delay time varies monotonically with each successive half period from an initial delay time to a final delay time. In the presently preferred embodiment, the rate of change first firing pulse delay time from half period to half period is a programmable constant.

According to another aspect of the present invention, the triac controller further comprises an auto-retriggering subcircuit coupled to the triac driver and the soft start subcircuit that causes the triac driver to produce a second firing pulse at a predetermined retriggering delay time from an end of the first firing pulse if the triac is not in an on conduction state after the end of the first firing pulse during a same half period of the alternating current power supply. Optionally, the auto-retriggering subcircuit causes the triac driver to produce retriggering firing pulses periodically if the triac is not in the on conduction state after the end of the first firing pulse for so long as the triac is not in the on conduction state during the same half period of the alternating current power supply. The auto-retriggering subcircuit monitors the triac control signal in order to determine whether or not the triac is in the on conduction state. As a further option, the auto-retriggering subcircuit is inhibited from causing the triac driver to produce retriggering firing pulses during a predetermined retriggering mask period at an end of the same half period of the alternating current power supply. During a power-up situation, the initial delay time is a maximum value corresponding to less than the half period of the alternating current power supply, and the final delay time is a minimum value determined by a final output level.

In some embodiments, the final output level is derived from a set signal. The soft start subcircuit includes a table specifying a plurality of predetermined first firing pulse delay values. According to another aspect of the present invention, the set signal is used to determine an index into the table so that one of the plurality of the predetermined first firing delay values is selected which corresponds to the final output level. The soft start subcircuit further includes an analog to digital converter coupled to the set signal that produces the index.

The ADC output 216 points to 1 of 16 values in the ROM lookup table. For a 50 Hz alternating current power supply, these firing delay values in the table are values between 0 and 1000. The firing delay values define the moment at which the triac will be activated. The resolution is thus the duration of half a cycle of the AC line. For example, 10 milliseconds for a 50 Hz system, divided by 1000; therefore, 10 microseconds for a 50 Hz system. When changing the speed by choosing any other set point in the ROM table, the system will increment or decrement from the previous firing delay value to the newly selected firing delay value. This incrementing is performed in an internal register. The rate at which this is done is defined by parameter ATTN.

The table of predetermined first firing delay values is programmable, and may be programmed by the soft start subcircuit with values derived from a length of the half period. In the presently preferred embodiment of the present invention, the plurality of predetermined first firing delay values is monotonically organized with respect to the index into the table, so that the power delivered to the load is monotonically related to the position of an external speed control potentiometer during a soft start operation. In a presently preferred embodiment, the slope can be adjusted so that the ramp up duration from minimum to maximum power is within the range of 0.5 sec. to 12 sec.

One of the responsibilities of a motor controller according to the present invention is to facilitate the proper ignition of the triac for inductive and resistive loads, while keeping the triac's current consumption to a minimum. Additional features of the integrated circuit include a frequency locked loop for stable ignition point.

The triac controller's soft start operation according to the present invention thus has the benefit of eliminating current surges which would conventionally occur during start up. The triac controller's integrated design according to the present invention has the advantage of minimizing external components required for proper control of the triac. The triac controller according to the present invention has the advantage that it drives virtually any resistive or inductive load. The triac controller has built-in thermal protection. In the presently preferred embodiment, the triac controller is constructed using a digital design for stable triac control, and is therefore immune to lifetime and thermal drift. The triac controller has low power consumption, and in the presently preferred embodiment, is ideally suited for operation at 50 Hz or 60 Hz.

### BRIEF DESCRIPTION OF THE DRAWINGS

FIG. 1 plots rotational speed versus time and current consumption versus time for a motor during a conventional power on operation using a conventional triac power supply circuit configuration without the benefits afforded by the triac controller according to the present invention.

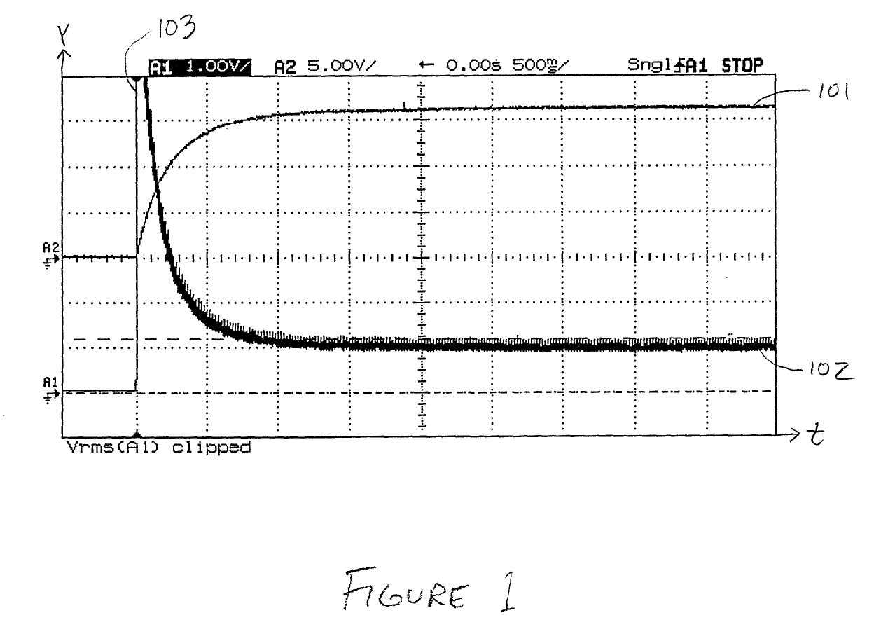

FIG. 2 is a block diagram of a triac controller according to the present invention.

FIG. 3 illustrates a soft start circuit application of the triac controller and triac according to the present invention, and a motor to be driven by an alternating current power supply, in which the motor runs at full speed after a soft start operation.

FIG. 4 illustrates a soft start circuit application of the triac controller and triac according to the present invention, and a motor to be driven by an alternating current power supply, in which the motor runs at a speed that is determined by a potentiometer setting after a soft start operation has completed.

FIG. 5 illustrates another soft start circuit application of the triac controller and triac according to the present invention, and a motor to be driven by an alternating current power supply, in which the motor runs at speed that is determined by a potentiometer setting after a soft start operation has completed.

FIG. 6 plots rotational speed versus time and current consumption versus time for a motor during a soft start operation occurring at power on using the triac controller according to the present invention in any of the configurations shown in FIGS. 3, 4, or 5.

The various features, advantages, and benefits of the present invention are more fully explained in the following Description of the Specific Embodiments, which discusses the Figures in narrative form.

### DESCRIPTION OF THE SPECIFIC EMBODIMENTS

An AC powered motor arrangement includes a triac and an integrated circuit configured to address the control requirements for use in low cost applications. Thus, there is arranged on a single silicon integrated circuit all the elements needed for the generation of the signals to control an ac mains driven motor in a low cost domestic application. Although the invention is described with reference to a motor driven by an alternating current power supply (240 volt AC), the invention applies equally to any ac motor driven by any power supply (e.g., 110 volt AC, 220 volt AC, etc.)

In a normal domestic appliance application such as a vacuum cleaner, there is a motor whose speed is controlled to predetermined or continuously variable limits as part of the normal functional requirements for the application. This control not only ensures that the motor speed is maintained at the desired level selected by the user but also limits the rate of change of the speed and thus also the current drawn by the motor to within defined limits. The key requirements for a low cost motor speed control in a domestic application include minimal component count, motor current control, thermal protection, minimum wiring at safe voltages to user controls, and especially optimal operation without the need for presets or other set up controls or switches.

A triac (bidirectional triode thyristor) motor controller such as provided according to the present invention is ideal for low cost applications. The motor controller according to the present invention typically includes a triac that controls the current fed to the motor. In the presently preferred embodiment, a clock runs at a frequency which is high in comparison to the period of the alternating current power supply. A number of discreet and stable timeslots are synchronized with the waveforms of the alternating current mains power supply. In an embodiment, the motor controller according to the present invention also typically includes a speed select input that specifies the desired final motor speed. The speed select input produces a voltage which is interpreted by the triac controller according to the present invention to determine a timing reference for the triggering of the triac so as to set the speed of the motor as closely as possible to the desired speed. The motor controller according to the present invention controls the rate of change of speed of the motor by changing the selection of timeslots used for creating a triac first firing pulse from half-period to half-period in a monotonic fashion. In this manner, the firing delay time from the zero crossing time to the first firing pulse increases gradually when the motor is decreasing its speed, and decreases gradually when the motor is decreasing its speed.

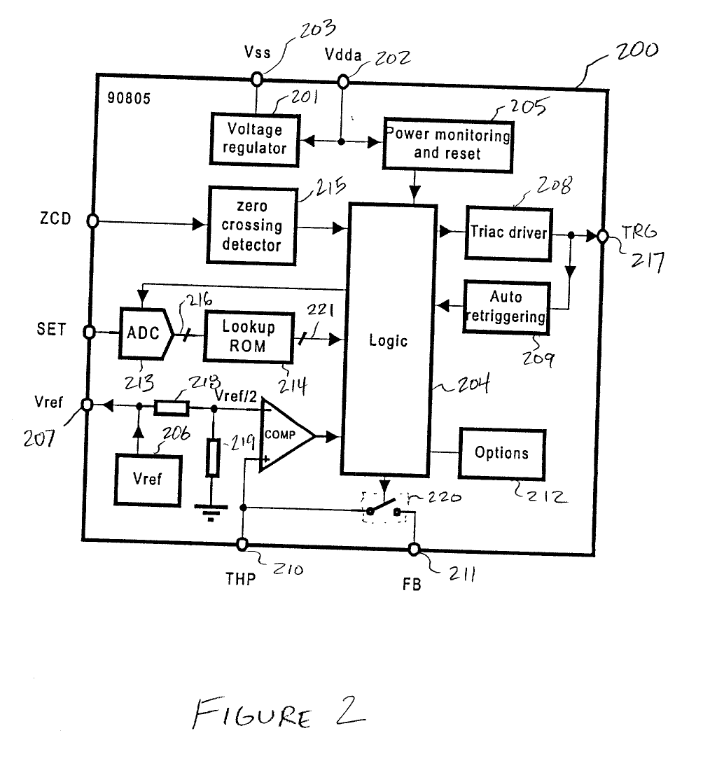

Description of Block Diagram FIG. 2 illustrates a block diagram 200 of a triac controller integrated circuit according to the present invention.

Voltage Regulator

A voltage regulator subcircuit 201 receives its positive supply voltage through pin VDDA 202 and negative supply voltage through pin VSS 203. In its preferred embodiment, the digital part (including logic 204) and some of the peripheral blocks are power supplied by an internally generated VDD that is approximately 5V.

Analog Power on Reset

The analog power on reset block 205 tracks the voltage at pin VDDA 202, and permits generation of firing pulses for the triac only if VDDA is greater than approximately 13V. Because in most applications, the power to the integrated circuit 200 is derived through the alternating current power supply by means of a half-wave rectifier, if the voltage at pin Vdda 202 is less than 13V, the power monitoring and reset block 205 determines that the motor is not properly supplied by the alternating current power supply. Thus, the power monitoring and reset block 205 causes a reset condition when the voltage at pin Vdda 202 is less than 13V.

Oscillator

In the presently preferred embodiment, an on-chip oscillator (not shown) generates a clock having a frequency much higher than the freqency of the alternating current power supply. All timing constraints within the integrated circuit are derived from this clock.

Frequency Locked Loop

A frequency locked loop circuit is implemented to obtain a clock frequency from a current controlled oscillator, by using the alternating current power supply as a reference. Preferrably, a successive approximation algorithm is used at power on in order to minimize the time for the oscillator adjustment.

Reference Voltage

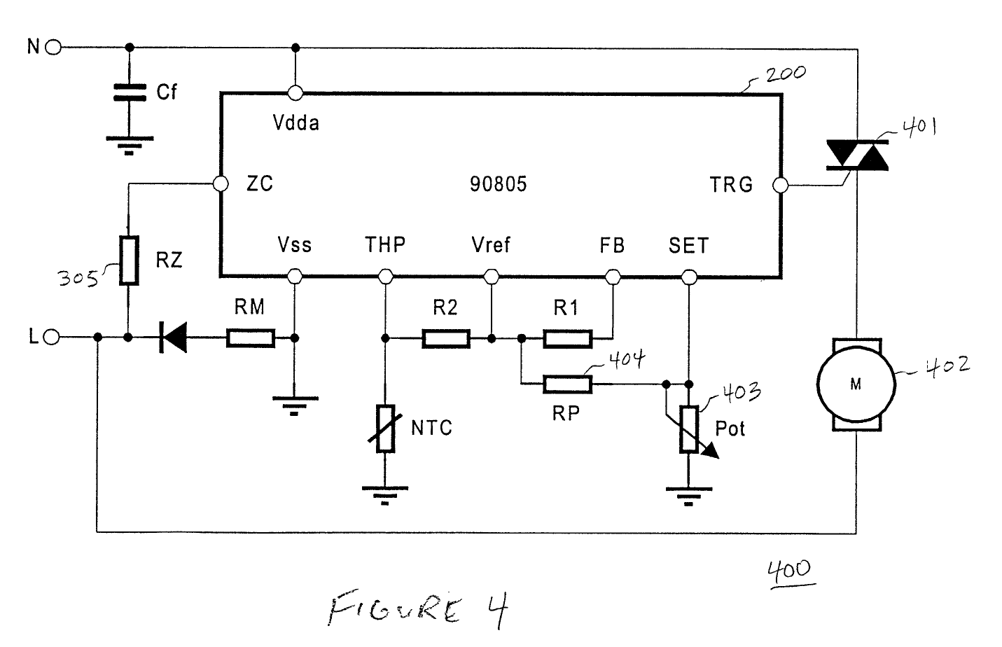

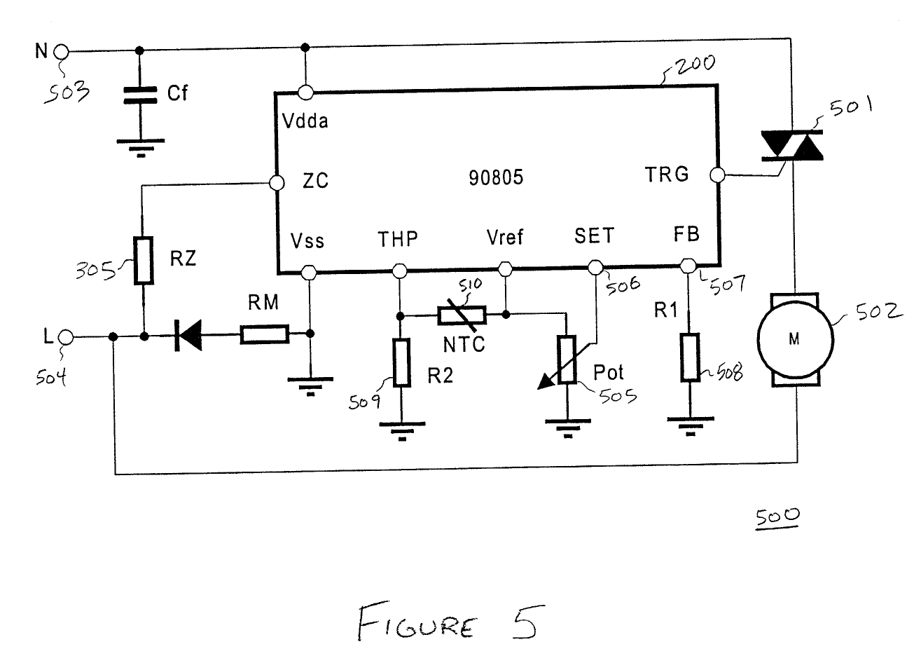

A reference voltage generation block 206 generates a reference voltage Vref which is available at an output pin 207. In many applications, such as illustrated in FIGS. 4 and 5, the reference voltage Vref 207 is used to supply an external potentiometer in order to allow a user to specify different speed settings.

Logic

Logic block 204 performs all control functions necessary to realize timing synchronization, smooth soft start, and the production of proper triac firing pulses to turn on the triac, so that the motor runs at a defined speed.

Triac Driver

The triac driver 208 is able to directly drive the gate of a triac through output pin 217 of the integrated circuit 200. The triac driver 208 is able to directly drive a triac gate, thereby defining the triacs gate current and therefore operates as a current generator for the triac's gate terminal. No need exists for an external resistor for current limitation.

Auto Retriggering

The auto-retriggering block 209 determines if the triac being driven by the triac controller is an on conduction state after each firing pulse. If the triac is in an off conduction state 20 us after a firing pulse, a new pulse is generated.

Thermal Protection

The integrated circuit 200 is able to supply an external protection circuitry, typically an NTC resistor with reference resistor, to track the ambient temperature. If the voltage at the THP pin 210 equals Vref/2, then the thermal protection is activated and the integrated circuit sets the firing angle defined by the value in read only memory 214 address 1. A resistor connected to a feedback pin FB 211 can introduce hysteresis in the detection level.

Options

The options block 212 defines different modes of the integrated circuit's operation.

Analog to Digital Converter

The analog signal from the user-controllable potentiometer, which defines the speed setting, is transferred into digital by a four-bit analog-to-digital converter 213. The voltage reference for the analog-to-digital converter is the voltage used to supply the potentiometer.

Read Only Memory

In the presently preferred embodiment, the four-bit digital words from the Analog to Digital Converter 213 act as the address of a read only memory 214 table in which the different firing angles are programmed. This means that up to sixteen different firing angles can be selected.

Zero Cross

The zero crossing block 215 determines the zero crossing times at which the alternating current power supply voltage crosses zero level. An accurate detection allows good synchronization, so firing pulses from the triac driver 208 driving the triac can be generated at the right moment relative to the zero crossing times.

Power On Reset

The power on reset circuitry contained within the power monitoring and reset block 205 ensures a correct start of the digital portion of the integrated circuit 200. The reset signal goes up for VDD greater than Vdporh and down for VDD less than Vdporl. “Vdporh” is the high level threshold having a typical value of 2.5 V. “Vdporl” is the low level threshold having a typical value of 2.0 V. “Vdphyst” is the hysteresis voltage having a typical value of approximately 0.5 V.

With respect to the analog portion of the integrated circuit 200, “Vaporh” is a high level threshold having a minimum value of 12 V, a typical value of 13 V, and a maximum value of 14 V, while “Vaporl” is a low level threshold having a minimum value of 9 V, a typical value of 10 V, and a maximum value of 11 V. “Vaphyst” is the hysteresis voltage of the analog portion having a minimum value of 2 V, a typical value of 3 V, and a maximum value of 4 V.

Zero Cross Detector

The high and low level thresholds for the first and second analog comparators (not shown) in the zero cross detector 215 are derived from the analog supply voltage VDDA. The zero cross detector 215 detector contains two comparators with hysteresis. The first comparator (not shown) has its reference at VDDA. The high level threshold for the first comparator, Vzc1h, is VDDA+0.5V. The low level threshold for the first comparator, Vzcll, is VDDA−0.5V. The high level threshold for the second comparator, Vzc2h, is VDDA−1.5V, and the low level threshold for the second comparator, Vzc2l, is VDDA−2.5V. The external resistor RZ 305 has a typical value of 470 kilo ohms when the alternating current power supply is 230 Volts.

Triac (Ignition) Driver 208

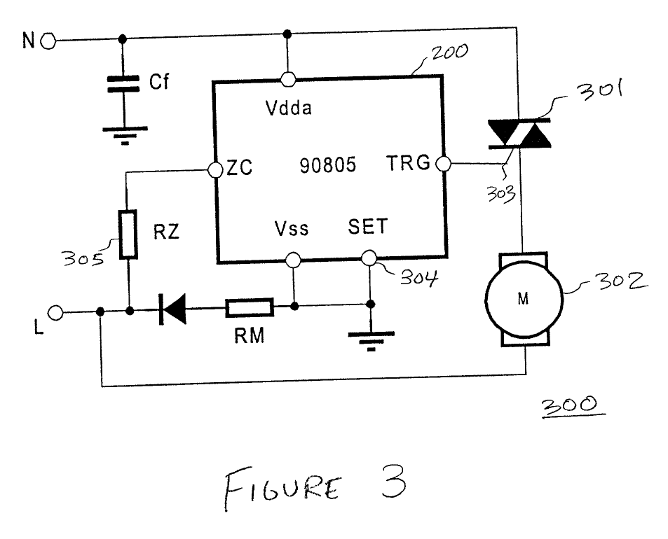

The triac driver 208 operates as a current generator to fire the triac (for example, 301, 401, or 501, in FIGS. 3, 4, and 5, respectively) into an on conduction state through its gate terminal.

For most typical triac's used in conjunction with the presently preferred embodiment of the present invention, the triac gate current required for firing the triac, ITRG, is typically around 60 mA, with a minimum of approximately 30 mA, and a maximum of approximately 90 mA. The triac driver can drive the gate of the triac whenever VDDA is greater than Vaporh.

The Analog to Digital Converter 213

The resolution of the analog to digital converter 213 is four bits, and the reference voltage Vref is typically 5 volts, a minimum of 4.6 volts, and a maximum of 5.4 volts.

Debounce of analog to digital converter 213

The result from the external potentiometer (for example, 403 in FIG. 4, or 505 in FIG. 5) used to set the final power must not jump from one read only memory 214 position to the other when the physical position of the potentiometer has not changed, therefore a special debouncing circuit (not shown) is included. To improve noise immunity the internal analog to digital converter has a five-bit resolution. The least significant bit is only used to improve immunity, the other four bits are used to access the read only memory lookup table. The debounce circuit compares the five bit digital present value with the five bit previous digital value. The present value is accepted only if the absolute difference between the present value and the previous value is greater than one least significant bit. Thereby, flickering between two adjacent power settings is eliminated when the potentiometer is turned to a position very close to the boundary between two power settings.

Power Settings (read only memory 214 table)

The analog to digital converter 213 output data is applied after debouncing at the address bus of the read only memory 214, and the corresponding power settings are available at its data output SETP [9:0] 221. The contents of the read only memory 214 can be defined freely; it does not need to be linearly or continuous. When the potentiometer setting is changed from one position to the other, the phase angle is moved to the new position via a soft start operation according to the present invention, thereby avoiding abrupt changes in the current through the triac and the power consumed by the motor. For programming the different speed settings in the read only memory 214 table, the following formula can be used, given ti (in msec) is the delay from the previous zero crossing to the moment of ignition:

ROMi[9:0]=ti*2*Fmains−10

For example, for a phase angle of 50%, ti=5 msec for a 50 Hz alternating current power supply, and thus:

ROMi[9:0]32 5*2*50−10=490

The value programmed into the Read Only Memory 214 should not be negative, negative values cannot be programmed. In addition, very small values should not be programmed.

In any given half period, for a fully resistive load, the power delivered is proportional to the square of the amplitude of the alternating current power supply and the following expression.

1/(4*Fmains)−ti/2+sin(4*π*Fmains*ti)/(8*π*Fmains).

The values in the read only memory 214 may be computed so as to increase power by a constant amount for each of the sixteen power settings.

Soft Start

A soft start operation according to the present invention is initiated after the supply voltage at pin Vdda 202 has been built up. The soft start operation according to the present invention provides a gradual start-up for the motor and automatically ensures the optimum run-up time. Thus, the motor increases its speed monotonically from zero to its final speed. The triac controller 200 according to the present invention fires the motor with current through the triac by applying a first firing pulse to the gate of the triac at some first firing delay time after the zero crossing time during each half period of the alternating current power supply.

During any given half-period, which by definition begins at the zero crossing time, the triac is in an OFF conduction state until the triac provides a first firing pulse. Therefore, no power is provided to the load until a first firing pulse is applied to the gate of the triac.

If the first firing pulse is applied and succeeds in turning the triac into an ON conduction state instantaneously after the zero crossing time, then the maximum power for that half period is applied to the load because the triac begins delivering power to the load immediately as soon as the alternating current power supply has a non-zero voltage.

The firing pulse supplied by the triac driver 208 is always a current, and is always flowing into (or out of) the pin TRG 217. However, when the triac is fired and conducting a current, this current generates a voltage on pin TRG 217 which is positive during half-periods in which the alternating current power supply is providing a positive supply voltage and which is negative during half-periods in which the alternating current power supply is providing a negative supply voltage. This voltage, generated by the current in the triac, is measured by the auto-retriggering block 209 to evaluate whether the triac is on or not.

If the first firing pulse is applied and succeeds in turning the triac into an ON conduction state only shortly before the zero crossing time during a given half period, then only a small amount of power is delivered to the load because the triac provided no power to the load for the majority of the half period and only begins applying power to the load when the magnitude of the alternating current supply voltage is decreasing toward zero, at which time the zero crossing time occurs for the next half period having opposite polarity. The triac always turns off by the zero crossing time of the next half period having opposite polarity.

Upon the beginning of a soft start operation following power on, the firing pulse is initially provided with a very small phase angle, therefore a first firing delay time very close to one half the alternating current power supply period, since it is desired to begin a soft start operation beginning at power up with the smallest possible power provided for by the read only memory table 214. The phase angle is then increased up to the phase angle defined by the potentiometer setting. The rate of increase of the phase angle is defined by the option ATN[6:0]. This option defines the time to increase the phase angle from minimum to maximum. If the phase angle selected by the potentiometer is not the maximum phase angle, then the soft start run-up time is decreased proportionally.

In other words, the soft start run-up (or run-down) time selected by the option ATN[6:0] determines the rate at which the first firing pulse delay times change over sequential half-periods from an initial delay time to a final delay time. If the initial delay time is greater than the final delay time, then the triac controller is increasing the power delivered to the load. Conversely, if the initial delay time is less than the final delay time, then the triac controller is decreasing the power delivered to the load.

The delay times according to the present invention are programmed into read only memory 214 so that the relationship between the ROM address 216 and the delay times is monotonic. In the case illustrated below, the minimum delay time corresponding to the maximum power is in the highest read only memory location, and the maximum delay time corresponding to the minimum power is in the lowest read-only memory location. The contents of the intermediate addresses vary monotonically between the minimum and maximum first firing delay times.

Therefore, each sequentially higher read only memory address holds a first firing delay time that specifies an increasing amount of power to be driven to the load.

Firing

The soft start circuit generates a predefined set of values for the ignition angle IGN stored in the read only memory 214. These values are digitally compared with the value of a down counter, which is clocked by the clock for the digital portion DCLK at 100 kHz (the resolution is 10 us) and is cleared at beginning of every half period of the alternating current power supply. When the counter value becomes equal to IGN the triac driver 208 produces a first firing pulse with duration 20 us, 40 us, 80 us, or 320 us depending upon the configuration chosen by DUTS[1:0].

According to another aspect of the present invention, the retriggering circuit determines whether or not the triac is in the ON conduction state, and if not additional firing pulses are generated every 20 us (with respect to the end of the previous firing pulse) until auto-retriggering subcircuit 209 determines that the triac has fired. Thus, if two DCLK cycles after the trailing edge of the first firing pulse, the triac is not yet in the ON conduction state, the triac driver sends a second firing pulse.

In the presently preferred embodiment, the auto-retriggering subcircuit 209 causes the triac driver 209 to produce retriggering firing pulses periodically until it determines that the triac has fired and is therefore in the ON conduction state.

Thermal Protection

An external circuit supplied by Vref defines the voltage at pin THP 210. This voltage is proportional to the ambient temperature Tamb. The voltage is tracked by an internal comparator referred to as VREF/2 created by resistors 218 and 219. The tracking process is sampled periodically. When internal switch 220 is ON, the integrated circuit 200 determines if the ambient temperature Tamb is greater than a predefined value. If it is, then the motor (or load) is driven to operate at the speed (or power) defined in the first read only memory 214 address. During any times at which the internal switch 220 is OFF, the integrated circuit 200 according to the present invention determines what mode is defined by the external elements. For example, two-wire or three-wire potentiometer connections are illustrated in FIGS. 4 and 5, respectively.

A reconnection of the elements used for thermal protection is needed only to define the active mode of operation. The temperatures for which thermal protection becomes active or not are defined by the external elements, keeping in mind that the comparator refers to an internally generated VREF/2 within the integrated circuit 200.

In the case in which thermal protection is not used, pin THP should be connected to pin FB, which is connected either to Vss or to Vref, depending on the mode.

2-wire mode, if V(FB)=VREF

3-wire mode, if V(FB)=VSS

Pinout

The integrated circuit 200 according to the present invention is suitable for packaging in a standard package 8-pin dual inline package. (Known as DIP-8, PDIP-8, DIL-8, and PDIL-8). The SET input pin is a potentiometer input; the THP input pin is for thermal protection; the FB input pin is a feed back pin used to create hysteresis for thermal protection; the ZC input pin is for detecting zero crossing; the TRG output pin is the triac driver output; the VSS supply pin is for supplying a ground voltage; the VDDA supply pin is the high level supply; and the VREF output pin is the reference voltage.

ESD

All I/O pins must withstand the normalized ESD pulses up to 2 kV (100 pF /1.5 kilo ohms). The pins will be stressed in both polarities, with respect to the combination of all supply pins.

Firing angle definition

The firing angles, and corresponding motor speeds, can be defined in ROMi[9:0] according to the present invention. This is the read only memory 214 table which is addressed by the analog to digital converter 213 reading the potentiometer setting. The read only memory 214 contains 16 words of 10 bits. For programming, the different speed settings in the read only memory 214 table, following formula can be used, given ti (in msec) is the delay from the previous zero crossing to the moment of ignition: With: Fmains=frequency of the mains (in Hz).

The value should not be negative: very small values cannot be programmed. The content of the read only memory 214 can be defined freely: it does not need to be linear or continuous. However for a proper soft start generation under all conditions, the value with minimum firing angle (thus maximum speed) must be in the highest read only memory 214 address. The default values at the read only memory addresses are as follows in the presently preferred embodiment:

address 0, value 590

address 1, value 567

address 2, value 544

address 3, value 522

address 4, value 500

address 5, value 477

address 6, value 456

address 7, value 434

address 8, value 411

address 9, value 387

address 10, value 362

address 11, value 335

address 12, value 305

address 13, value 273

address 14, value 231

address 15, value 112

If the firing delay values are monotonically related to the address, as they are above, then a soft start operation is performed by using an initial delay value at an initial address and then ending at a final delay value at an ending address. For example, for a transistion from the minimum power to the maximum power, the delay value from address 0 determines the first firing pulse delay time during a first half period of the soft start operation, and the delay value from address 15 determines the first firing pulse delay time during a last half period of the soft start operation. Thus, in this example, the first firing pulse delay time in address 0 corresponds to the initial delay time, and the first firing pulse delay time in address 15 corresponds to the final delay time. According to the present invention, the programmable rate variable determines a rate of change of from the initial delay time to the final delay time. In the presently preferred embodiment, the rate of change of the delay time from the initial delay time to the final delay time is constant from half-period to half-period. The first firing pulse delay time is adjustable from half period to half period at a resolution of 10 microseconds, which is one clock cycle of the digital clock DCLK that operates at a frequency of 100 kHz. For example, according to the present invention, it is possible to change the first firing pulse delay time by one or more DCLK periods every nth half period, where n is some whole number. If the soft start procedure increases the first firing pulse delay time by one DCLK period every 10 half-periods (n is 10), then the first firing pulse delay time is the same for ten consecutive half periods and then changes by a DCLK period. This results in a very slow soft start operation. It is also possible according to the present invention to change the first firing pulse delay time by j DCLK periods with each consecutive half-period. For example, if j is 10, then the first firing pulse delay time changes by 10 DCLK periods during every half period during a soft start operation, thereby resulting in a faster soft start operation.

Maximum phase angle

Independent of the phase angle definitions in the read only memory 214 table, a maximum phase angle can be defined. This is the phase angle that will be applied immediately after the power on sequence, and is therefore the first phase angle in the soft start sequence. This maximum phase angle is defined in MIN[9:0] with the formula:

MIN[9:0]=Tini*2*Fmains−10

With:

Tini=the initial phase angle (in msec)

Fmains=frequency of the mains (in Hz)

Default value:

Tini=7 msec and Fmains=50 Hz, thus MIN[9:0] is 690.

Soft start time duration

There are 7 bits ATN[6:0] used to define the duration of the soft start time. The bits can be calculated with following formula:

Ts=((Tini−Tmin)*ATTN)/62.5

With:

Ts=the duration of the soft start (in sec.)

Tini=the initial phase angle defined by MIN[9:0] (in msec)

Tmin=the phase angle corresponding to the value in the highest read only memory 214 address (in msec)

ATTN=bin2dec(ATN[6:0]+1), a value between 2 and 128.

Default value:

Tini=8 msec, Tmin=1.84 msec, ATTN=32, thus Ts=3.15 sec.

Firing pulse duration

The duration of the firing pulses can be defined by the bits DUTS[1:0] according to following table. The default value is 20 usec.

If DUTS[1:0] is 00, then the duration of each firing pulse is 320 microseconds; if DUTS[1:0] is 01, then the duration of each firing pulse is 80 microseconds; if DUTS[1:0] IS 10, then the duration of each firing pulse is 40 microseconds; and if DUTS[1:0] is 11, then the duration of each firing pulse is 20 microseconds.

Enable Retriggering

With bit RTRIG set to 1, triac retriggering is enabled. The retriggering circuit checks whether the triac is ON, if not additional firing pulses are generated every 20 us (with respect to the end of the previous firing pulse) until firing of the triac. With bit RTRIG set to 0, triac retriggering is disabled. For each triac firing two pulses are generated with a delay of 20 usec (with respect to the end of the previous firing pulse). The default value is triggering enabled.

Retriggering Mask

With the option MINA[3:0], it is possible according to the present invention to define a zone at the end of each half cycle of the alternating current power supply voltage in which it is impossible to generate retriggering pulses. This has two purposes with some (non inductive) loads the current can become quite small at the end of each half cycle, and triac may change to an off conduction state as the conditions necessary for forward bias are eliminated. This can eventually activate the retriggering circuit which will unnecessarily generate additional firing pulses thus undesirably increasing the current consumption. Moreover, when generating a retriggering pulse just before the zero crossing, this pulse could overlap into the next half period of opposite polarity. With some (non inductive) loads, this can undesirably lead to false triggering at full power during the next half period. Therefore, the generation of retriggering pulses at the end of the half period must be avoided. The bits MINA[3:0] are defined according to the following formula:

Tmina*2*Fmains=MINA[3:0]*64

With:

Tmina=the phase angle from which retriggering is prohibited (in msec)

Fmains=frequency of the mains (in Hz)

Default value:

MINA[3:0]=1101′b=13'd and Fmain=50 Hz, this means that retriggering is prohibited at 8.32 ms.

Soft start only Function regulator

The integrated circuit according to the present invention is supplied from the alternating current power supply voltage, by a half wave rectifier. The voltage at pin VDDA 202 is limited to ˜15.5V.

Soft Start Only

The integrated circuit according to the present invention is used to perform smooth soft start of an electrical motor. FIG. 3 illustrates a triac controller 300 according to the present invention connected to a motor in which only the soft-start features of the triac controller integrated circuit 200 are utilized. The triac controller 300 includes a triac 301 having a gate terminal 303 suitable for controlling current supplied to the motor 302 for detecting when the alternating current power supply voltage is applied and generates firing pulses for the triac 301. The motor 302 starts running, and the maximum speed (motor operating at full power) is reached after a predefined time. This application is defined by fixing pin 304 to a voltage of V(SET)=Vref. This means that, after a soft start generation, always the maximum speed (corresponding to the highest ROM address) is selected.

Soft Start With 2-Wire Setting

FIG. 4 illustrates a soft start circuit 400 application of the triac controller 200 and triac 401 according to the present invention, and a motor 402 to be driven by an alternating current power supply, in which the motor 402 runs at a speed that is determined by a potentiometer setting after a soft start operation has completed. The speed control is performed in addition to the soft start in this application. A potentiometer 403 in the 2-wire connection is used to define different speed settings. An additional resistor RP 404 with a resistance value equal to the maximum resistance of the potentiometer 403 is used to keep the analog to digital converter 213 input to be ratiometric. In this case, the input signal for the analog to digital converter 213 varies between 0 and VREF/2. The minimum speed corresponds to a potentiometer 403 set to its minimum value (i.e. Rpot=0). Maximum speed corresponds to a potentiometer 403 set to its maximum value. When the alternating current power supply voltage is applied to the system, the motor 402 starts running at a speed defined by the potentiometer 403, as soon as the soft start time has finished. A disadvantage of the 2-wire application is that, at maximum speed setting, the tolerance on the absolute value of the potentiometer 403 defines the tolerance of the voltage at the SET input 304, thus resulting in a less accurate selection of the maximum speed setting. This disadvantage is avoided when using a 3-wire application 500 such as illustrated in FIG. 5.

FIG. 5 illustrates another soft start circuit 500 application of the triac controller integrated circuit 200 and triac 501 according to the present invention, and a motor 502 to be driven by an alternating current power supply through terminals N 503 and L 504, in which the motor 502 runs at speed that is determined by a potentiometer 505 setting after a soft start operation has completed. The voltage at pin SET 506 is translated into a 4-bit value 216 (shown in FIG. 2) to address a ROM table 214 (shown in FIG. 2) in which the different phase angles are defined with 10-bit resolution. The 2-wire mode is selected by connecting pin VFB 507 to VREF (eventually via a resistor).

Resistors R1 508, R2 509, and NTC 510 are needed only in order to facilitate thermal protection, and otherwise can be left out of the circuit application 500.

Performance of Soft Start Mechanism.

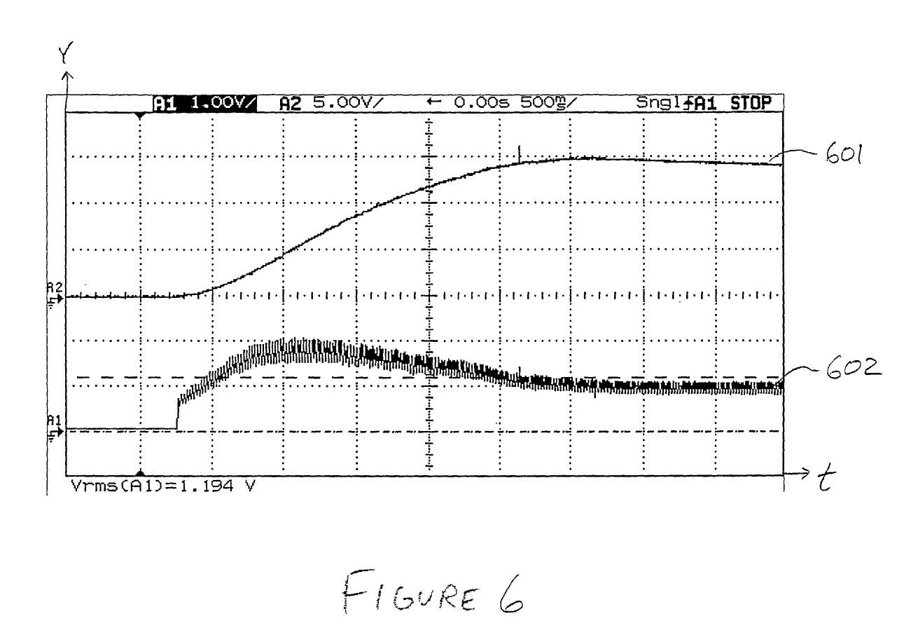

FIG. 6 shows rotational speed 601 in the Y-dimension plotted against time on the t-axis and current consumption 602 in the Y-dimension plotted against time on the X-axis for a motor during a soft start operation occurring at power on using a triac controller according to the present invention in any of the configurations 300, 400, or 500 shown in FIGS. 3, 4, or 5, respectively. The plots are a measurement of motor current (signal A1) and speed (signal A2) during startup for a particular motor. In the first plot, we have a soft start of approximately 3 seconds.

While the present invention has been described with reference to its presently preferred and alternative embodiments, those embodiments are offered by way of example, not by way of limitation. It is to be understood that various additions and modifications to the present invention can be made without departing from the spirit and scope of the invention. Accordingly, all such modifications are deemed to lie within the scope of the appended claims.

What is claimed is:

1. A triac controller, comprising:
a zero crossing detector that determines a zero crossing time at which an alternating current power supply having positive and negative half periods changes voltage polarity;
a triac driver that provides a triac control signal suitable for connection to a gate terminal of a triac, such that, when in a power-on condition, the control signal carries at least a first firing pulse during each half period of the alternating current power supply; and
a soft start subcircuit coupled to the triac driver and the zero crossing detector that directs the triac driver to produce the first firing pulse at a first firing pulse delay time after the zero crossing time, wherein during a soft start operation the first firing pulse delay time varies monotonically with each successive half period from an initial delay time to a final delay time.

2. A triac controllor as in claim 1, wherein the triac controller further comprises:
an auto-retriggering subcircuit coupled to the triac driver and the soft start subcircuit that causes the triac driver to produce a second firing pulse at a predetermined retriggering delay time from an end of the first firing pulse if the triac is not in an on conduction state after the end of the first firing pulse during a same half period of the alternating current power supply.

3. A triac controller as in claim 2,
wherein the auto-retriggering subcircuit causes the triac driver to produce retriggering firing pulses periodically if the triac is not in the on conduction state after the end of the first firing pulse for so long as the triac is not in the on conduction state during the same half period of the alternating current power supply.

4. A triac controller as in claim 3,
wherein the auto-retriggering subcircuit monitors the triac control signal in order to determine whether or not the triac is in the on conduction state.

5. A triac controller as in claim 3,
wherein the auto-retriggering subcircuit is inhibited from causing the triac driver to produce retriggering firing pulses during a predetermined retriggering mask period at an end of the same half period of the alternating current power supply.

6. A triac controller as in claim 1,
wherein the initial delay time is a maximum value corresponding to less than the half period of the alternating current power supply, and the final delay time is a minimum value determined by a final output level.

7. A triac controller as in claim 6,
wherein the final output level is derived from a set signal.

8. A triac controller as in claim 6, wherein the soft start subcircuit includes a table specifying a plurality of predetermined first firing pulse delay values.

9. A triac controller as in claim 8, wherein the set signal is used to determine an index into the table so that one of the plurality of the predetermined first firing delay values is selected which corresponds to the final output level.

10. A triac controller as in claim 8, wherein the soft start subcircuit further includes an analog to digital converter coupled to the set signal that produces the index.

11. A triac controller as in claim 8, wherein the table is programmable.

12. A triac controller as in claim 11, wherein the table is programmed by the soft start subcircuit with values derived from a length of the half period.

13. A triac controller as in claim 9, wherein the plurality of predetermined first firing delay values is monotonically organized with respect to the index into the table.

14. A triac controller as in claim 1, wherein a rate of change of the first firing pulse delay time during a soft start operation is a programmable constant.

15. A triac controller, comprising:
a zero crossing detector that determines a zero crossing time at which an alternating current power supply having positive and negative half periods changes voltage polarity;
a triac driver that provides a triac control signal suitable for connection to a gate terminal of a triac, such that, when in a power-on condition, the control signal carries at least a first firing pulse during each half period of the alternating current power supply; and
an auto-retriggering subcircuit coupled to the triac driver and the zero crossing detector that causes the triac driver to produce a second firing pulse at a predetermined retriggering delay time from an end of the first firing pulse if the triac is not in an on conduction state after the end of the first firing pulse during a same half period of the alternating current power supply.

16. A triac controller as in claim 15,
wherein the auto-retriggering subcircuit causes the triac driver to produce retriggering firing pulses periodically if the triac is not in the on conduction state after the end of the first firing pulse for so long as the triac is not in the on conduction state during the same half period of the of the alternating current power supply.

17. A triac controller as in claim 16,
wherein the auto-retriggering subcircuit monitors the triac control signal in order to determine whether or not the triac is in the on conduction state.

18. A triac controller as in claim 16,
wherein the auto-retriggering subcircuit is inhibited from causing the triac driver to produce retriggering firing pulses during a predetermined retriggering mask period at an end of the same half period of the alternating current power supply.

19. A motor controller, comprising:
a triac having a gate terminal suitable for controlling current supplied to a motor from an alternating current power supply having positive and negative half periods;
a zero crossing detector that determines a zero crossing time at which the alternating current power supply changes voltage polarity; and
a triac driver that provides a triac control signal to a gate terminal of a triac, such that, when in a power-on condition, the control signal carries at least a first firing pulse during each half period of the alternating current power supply such that the first firing pulse is produced at a first firing pulse delay time after the zero crossing time, wherein during a soft start operation the first firing pulse delay time varies monotonically with each successive half period from an initial delay time to a final delay time.

20. A triac controller as in claim 19,
wherein the initial delay time is a maximum value corresponding to less than the half period of the alternating current power supply, and the final delay time is a minimum value determined by a final output level.

21. A triac controller as in claim 20,
wherein the final output level is derived from a set signal.

22. A triac controller as in claim 19, wherein a duration of the soft start operation is also a function of a programmable rate variable.

23. A triac controller as in claim 22, wherein the duration of the soft start operation is also a linear function of a difference between the initial delay time and the final delay time.
